(19) United States
(12) Patent Application Publication
(10) Pub. No.: US 2019/0176539 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,182

(22) Filed: Dec. 5, 2018

(30) Foreign Application Priority Data
Dec. 13, 2017 (JP) 2017-238866

(51) Int. Cl. B60C 11/13; B60C 11/03; B60C 11/11; B60C 11/12

(52) U.S. Cl. CPC B60C 11/1392; B60C 11/0309; B60C 11/032; B60C 11/11; B60C 11/1204; B60C 11/1307; B60C 2200/04; B60C 2011/0358; B60C 2011/0388; B60C 2011/1213; B60C 2011/1227; B60C 2011/1338; B60C 2011/0346

(57) ABSTRACT

In a pneumatic tire in which protrusions (90 and 95) are provided in main grooves (10 and 15) extending in a circumferential direction of the tire, upper surfaces (91 and 96) of the protrusions (90 and 95) are inclined so as to be higher on a tire grounding end side and lower on a tire equator side, surfaces (92 and 97) on stepped sides of the protrusions (90 and 95) extend in the tire width direction, and surfaces (93 and 98) on kick-out sides of the protrusions (90 and 95) are inclined such that a portion closer to the tire equator side approaches to the surfaces (92 and 97) on the stepped sides.

### CROSS-REFERENCE TO RELATED APPLICATIONS

This application is based on Japanese Patent Application No. 2017-238866 (filed on Dec. 13, 2017) and claims priority from Japanese Patent Application No. 2017-238866. The present disclosure incorporates entire contents of Japanese Patent Application No. 2017-238866.

### TECHNICAL FIELD

The present disclosure relates to a pneumatic tire.

### BACKGROUND ART

As illustrated in Patent Document 1, a pneumatic tire is known in which protrusions that span from a side wall of an outer side of a shoulder main groove to a bottom of the groove are provided in the shoulder main groove of a tread. The protrusions may prevent a land portion such as a rib of the tread from being collapsed during cornering.

Patent Document 1: Japanese Patent No. 4800604

### DISCLOSURE OF THE INVENTION

### Problem that the Invention is to Solve

However, when the protrusions exist in the main groove, drainage performance for water or snow by the main groove may be impaired. Further, in the related art, the influence of the protrusions in the main groove on traction property during traveling on snow has not been examined.

Therefore, the present disclosure is to provide a pneumatic tire having protrusions in a main groove, which is capable of preventing a land portion from being collapsed during cornering, and hardly impairs drainage performance for water or snow so that the protrusions in the main groove contributes to an improvement in traction performance during traveling on snow.

### Means for Solving the Problem

In a pneumatic tire of an embodiment, in which protrusions are provided in main grooves extending in a circumferential direction of the tire, upper surfaces of the protrusions are inclined so as to be higher on a tire grounding end side and lower on a tire equator side, surfaces on stepped sides of the protrusions extend in the tire width direction, and surfaces on kick-out sides of the protrusions are inclined such that a portion closer to the tire equator side approaches to the surfaces on the stepped sides.

### Advantage of the Invention

In the pneumatic tire of the embodiment, since the upper surface is inclined so as to be higher on the tire grounding end side and lower on the tire equator side, the land portion is hardly collapsed during cornering. Further, the drainage performance for water or snow is excellent as compared with a case where the upper surface is not inclined like this. Further, since the surface on the stepped side of the protrusion extends in the tire width direction, the protrusion may contribute to an improvement in the traction performance during traveling on snow.

### BRIEF DESCRIPTION OF THE DRAWINGS

FIG. 1 A cross-sectional view in the width direction of a pneumatic tire of an embodiment.

FIG. 2 A tread pattern of the pneumatic tire of the embodiment.

FIG. 3 A perspective view of the vicinity of a main groove of the tread pattern of FIG. 2.

FIG. 4 (a) illustrates a cross-sectional view in the width direction of a center main groove, and (b) illustrates a cross-sectional view in the width direction of a shoulder main groove.

### BEST MODE FOR CARRYING OUT THE INVENTION

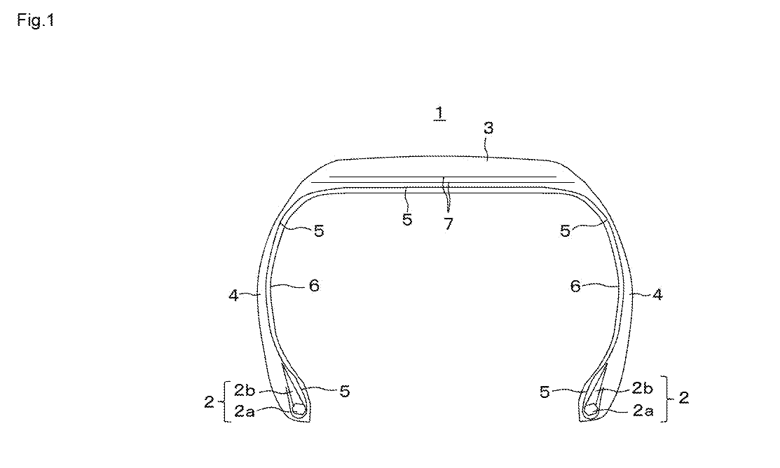

As illustrated in FIG. 1, a bead portion 2 is provided on both sides in a tire width direction of a pneumatic tire 1. The bead portion 2 is constituted by a bead core 2a made of a steel wire wound in a circular shape and a bead filler 2b made of rubber and provided on a radial outer side of the bead core 2a. A carcass ply 5 is laid across the bead portion 2 on both sides of the tire width direction. The carcass ply 5 is a sheet type member in which a plurality of ply cords arranged in a direction orthogonal to a circumferential direction of the tire are covered with rubber. The carcass ply 5 forms a frame shape of the pneumatic tire 1 between the bead portions 2 on both sides of the tire width direction, and surrounds the bead portions 2 by folding back from inside to outside in the tire width direction around the bead portions 2. A sheet type inner liner 6 made of rubber having low air permeability is adhered to the inside of the carcass ply 5.

One or a plurality of belts 7 are provided on the tire radial outer side of the carcass ply 5. The belt 7 is a member made by covering a plurality of steel-based cords with rubber. A tread rubber 3 having a grounding surface with a road surface (hereinafter, referred to as a “grounding surface”) is provided on the tire radial outer side of the belt 7. Further, a side wall rubber 4 is provided on both sides in the tire width direction of the carcass ply 5. In addition to these members, according to functional requirements of the pneumatic tire 1, members, for example, a belt lower pad or a chafer are provided.

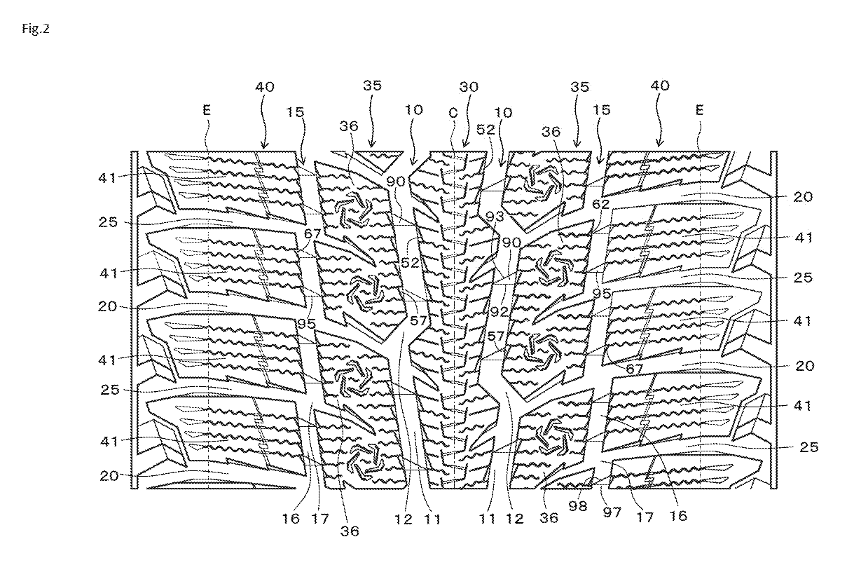

A tread pattern illustrated in FIG. 2 is formed on a surface of the tread rubber 3. In FIG. 2, the vertical direction is the circumferential direction of the tire, and the lateral direction is the tire width direction. In this tread pattern, as a main groove that extends in the circumferential direction of the tire and has a wide width, a total of four main grooves, that is, two center main grooves 10 in a center region in the tire width direction that is close to a tire equator C and two shoulder main grooves 15 in an outer region in the tire width direction that is close to a tire grounding end E are formed. Then, a center land portion 30 between the two center main grooves 10, a mediate land portion 35 between the center main groove 10 and the shoulder main groove 15, and a shoulder land portion 40 between the shoulder main groove 15 and the tire grounding end E are provided.

Here, the land portion is a portion formed by being partitioned by grooves. Further, the tire grounding end E is an end portion of the grounding surface in the tire width direction in a loaded state. The loaded state is a state where the pneumatic tire is rim-assembled into a normal rim to be a normal inner pressure and loaded by a normal load. Here, the normal rim is a standard rim defined by standards such as JATMA, TRA, and ETRTO. Further, the normal load is a maximum load defined in the above standards. Further, the normal inner pressure is an inner pressure corresponding to the maximum load.

The center main groove 10 includes long first groove portions 11 that extend obliquely with respect to the circumferential direction of the tire, and short second groove portions 12 that are inclined with respect to the circumferential direction of the tire and extend in a direction different from that of the first groove portion 11. Then, a first groove portion 11 and a second groove portion 12 are arranged alternately, and thus, the center main groove 10 is formed in a zigzag shape. In FIG. 2, a lower side is grounded first during rolling of the tire (that is, when the vehicle is traveling) As can be seen from the drawing, the first groove portion 11 is inclined such that a portion to be grounded later (in other words, a rear side in the rolling direction) heads toward the tire grounding end E side.

The shoulder main groove 15 includes long first groove portions 16 that extend obliquely with respect to the circumferential direction of the tire, and short second groove portions 17 that are inclined with respect to the circumferential direction of the tire and extend in a direction different from that of the first groove portion 16. Then, a first groove portion 16 and a second groove portion 17 are arranged alternately, and thus, the shoulder main groove 15 has a zigzag shape. As can be seen from FIG. 2, the first groove portion 16 is inclined such that a portion to be grounded later heads toward the tire grounding end E side.

Further, as lateral grooves that extend in the tire width direction, first lateral grooves 20 and second lateral grooves 25 are formed. The first lateral groove 20 traverses the shoulder land portion 40 and the mediate land portion 35, and extends to the center land portion 30 and is closed in the center land portion 30. Further, the second lateral groove 25 traverses the shoulder land portion 40, and extends to the mediate land portion 35 and is closed in the mediate land portion 35. Such first lateral grooves 20 and second lateral grooves 25 are alternately arranged in the circumferential direction of the tire. The second groove portion 17 of the shoulder main groove 15 overlaps with the first lateral groove 20 and the second lateral groove 25.

With the configuration of the groove as described above, the center land portion 30 between the two center main grooves 10 is configured to a rib extending in the circumferential direction of the tire without being divided by lateral grooves. Further, the mediate land portion 35 is divided by the first lateral groove 20, and thus, is a row of a plurality of mediate blocks 36 arranged in the circumferential direction of the tire. Further, the shoulder land portion 40 is divided by the first lateral groove 20 and the second lateral groove 25, and thus, is a row of a plurality of shoulder blocks 41 arranged in the circumferential direction of the tire. Two shoulder blocks 41 are provided for one mediate block 36.

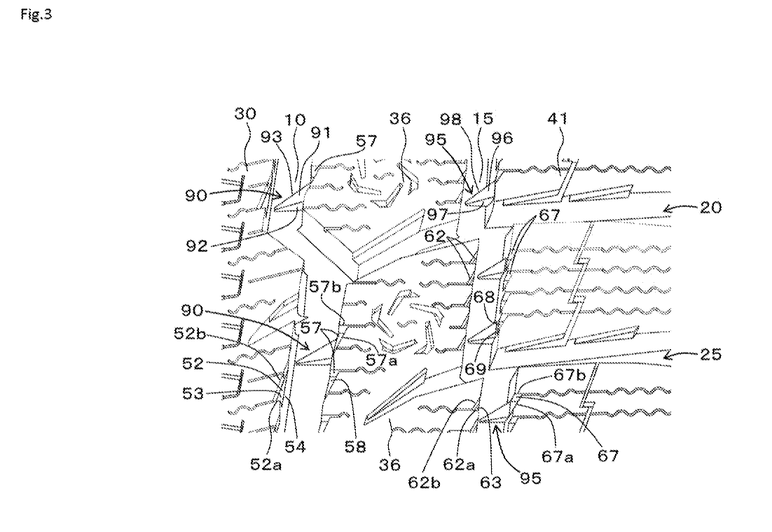

A plurality of notches 52 are formed on end portions of both sides of the width direction of the center main groove 30, respectively. In a plan view (that is, when viewed from the tire outer radial side), the notch 52 is a triangle formed with a boundary between the center main groove 10 and the center land portion 30 as one side. As illustrated in FIG. 3, a side 52a of the triangle on the stepped side during traveling (a side that is grounded first during traveling) extends toward the tire width direction more than a side 52b on the kick-out side during traveling (a side that is grounded later during traveling)

As illustrated in FIG. 3, a bottom surface 53 of the notch 52 is an upper surface of a shelf portion 54 that is higher than a bottom portion of the center main groove 10. Therefore, the notch 52 is shallower than the center main groove 10. A depth of the notch 52 (that is, a depth from the grounding surface to the bottom surface 53) may be 60% or less of the depth of the center main groove 10.

Further, a plurality of notches 57 are formed on an end portion of the center main groove 10 side of the mediate block 36. In a plan view, the notch 57 is a triangle formed with a boundary between the center main groove 10 and the mediate block 36 as one side. A side 57b of the triangle on the kick-out side during traveling extends toward the tire width direction more than a side 57a on the stepped side during traveling.

A bottom surface 58 of the notch 57 is an upper surface of a shelf portion that is higher than a bottom portion of the center main groove 10. Therefore, the notch 57 is shallower than the center main groove 10. A depth of the notch 57 (that is, a depth from the grounding surface to the bottom surface 58) may be 60% or less of the depth of the center main groove 10.

Further, a plurality of notches 62 are formed on an end portion of the shoulder main groove 15 side of the mediate block 36. In a plan view, the notch 62 is a triangle formed with a boundary between the shoulder main groove 15 and the mediate block 36 as one side. A side 62a of the triangle on the stepped side during traveling extends toward the tire width direction more than a side 62b on the kick-out side during traveling.

A bottom surface 63 of the notch 62 is an upper surface of a shelf portion that is higher than a bottom portion of the shoulder main groove 10. Therefore, the notch 62 is shallower than the shoulder main groove 15. A depth of the notch 62 (that is, a depth from the grounding surface to the bottom surface 63) may be 60% or less of the depth of the shoulder main groove 15.

Further, a plurality of notches 67 are formed on an end portion of the shoulder main groove 15 side of the shoulder block 41. In a plan view, the notch 67 is a triangle formed with a boundary between the shoulder main groove 15 and the shoulder block 41 as one side. A side 67b of the triangle on the kick-out side during traveling extends toward the tire width direction more than a side 67a on the stepped side during traveling.

A bottom surface 68 of the notch 67 is an upper surface of a shelf portion 69 that is higher than a bottom portion of the shoulder main groove 15. Therefore, the notch 67 is shallower than the shoulder main groove 15. A depth of the notch 67 (that is, a depth from the grounding surface to the bottom surface 68) maybe 60% or less of the depth of the shoulder main groove 15.

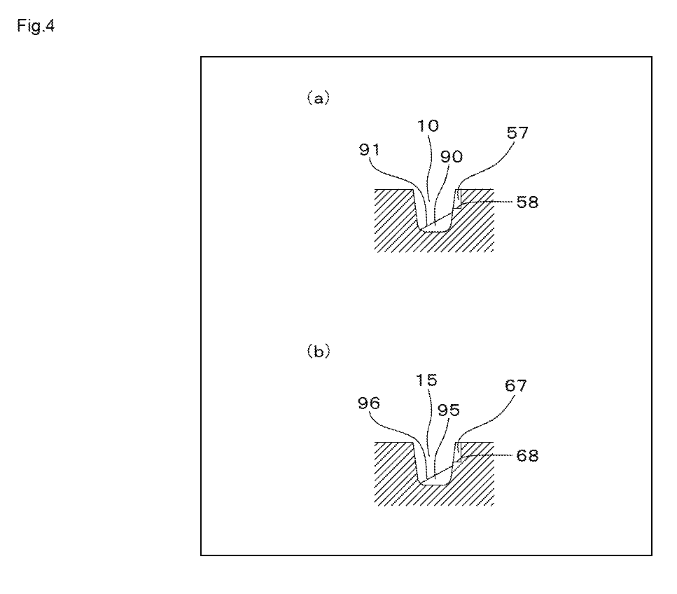

A protrusion 90 elevated from the bottom of the groove is provided in the center main groove 10. A height of the protrusion 90 from the bottom of the groove to the highest portion thereof is not limited, but, for example, is 40% to 50% (including 40% and 50%) of the depth of the center main groove 10. As illustrated in FIGS. 3 and 4 (a), an upper surface 91 of the protrusion 90 is inclined to be higher on the tire grounding end E side (that is, mediate block 36 side) and to be lower on the tire equator C side (that is, center land portion 30 side). Further, a surface 92 on the stepped side of the protrusion 90 extends in the tire width direction, and a surface 93 on the kick-out side of the protrusion 90 is inclined such that a portion closer to the tire equator C side approaches to the surface 92 on the stepped side. Therefore, the protrusion 90 becomes thinner toward the tire equator C side. The surface 92 on the stepped side of the protrusion 90 may be slightly inclined (e.g., within ±10°) with respect to the tire width direction.

The protrusion 90 may be provided to be adjacent to locations on both sides of the mediate block 36 in the circumferential direction of the tire. Further, the protrusion 90 may be provided at a location adjacent to the notch 57 of the mediate block 36. It is most desirable that the protrusion 90 is provided at a location adjacent to the notch 57 on both sides of the mediate block 36 in the circumferential direction of the tire. When the protrusion 90 is provided at the location adjacent to the notch 57 of the mediate block 36, the protrusion 90 is located at a location (that is, on the bottom side of the groove) lower than the bottom surface 58 of the notch 57.

Further, a protrusion 95 elevated from the bottom of the groove is provided in the shoulder main groove 15. A height of the protrusion 95 from the bottom of the groove to the highest portion thereof is not limited, but, for example, is 40 to 50% (including 40% and 50%) of the depth of the shoulder main groove 15. As illustrated in FIGS. 3 and 4 (b), an upper surface 96 of the protrusion 95 is inclined to be higher on the tire grounding end E side (that is, shoulder block 41 side) and to be lower on the tire equator C side (that is, mediate block 36) Further, a surface 97 on the stepped side of the protrusion 95 extends in the tire width direction, and a surface 98 on the kick-out side of the protrusion 95 is inclined such that a portion closer to the tire equator C side approaches to the surface 97 on the stepped side. Therefore, the protrusion 95 becomes thinner toward the tire equator C side. The surface 97 on the stepped side of the protrusion 95 may be slightly inclined (e.g., within ±10°) with respect to the tire width direction.

The protrusion 95 may be provided to be adjacent to locations on both sides of the shoulder block 41 in the circumferential direction of the tire. Further, the protrusion 95 may be provided at a location adjacent to the notch 67 of the shoulder block 41. It is most desirable that the protrusion 95 is provided at a location adjacent to the notch 67 on both sides of the shoulder block 41 in the circumferential direction of the tire. When the protrusion 95 is provided at the location adjacent to the notch 67 of the shoulder block 41, the protrusion 95 is located at a location (that is, on the bottom side of the groove) lower than the bottom surface 68 of the notch 67.

The protrusion 95 in the shoulder main groove 15 is larger in the number per unit length in the circumferential direction of the tire than the protrusion 90 in the center main groove 10.

As described above, in the pneumatic tire 1 of the embodiment, since the upper surfaces 91 and 96 of the protrusions 90 and 95 are inclined to be higher on the tire grounding end E side, it is possible to prevent collapsing of the mediate block 36 or the shoulder block 41 during cornering. Further, since the upper surfaces 91 and 96 of the protrusions 90 and 95 are inclined to be lower on the tire equator C side, and further the surfaces 93 and 98 on the kick-out side of the protrusions 90 and 95 are inclined such that portions closer to the tire equator C side approach to the surfaces 92 and 97 on the stepped side, a lot of water or snow can pass through the tire equator C side in the center main groove 10 or the shoulder main groove 15, so that the drainage performance for water or snow is secured. In addition, because the surfaces 92 and 97 on the stepped side of the protrusions 90 and 95 extend in the tire width direction, the protrusions 90 and 95 may press the snow entered into the center main groove 10 or the shoulder main groove 15 during traveling on snow. Therefore, the protrusions 90 and 95 contribute to an improvement in the traction performance during traveling on snow.

Further, since the protrusions 90 are provided adjacent to the locations on both sides of the mediate block 36 in the circumferential direction of the tire, it is possible to effectively prevent collapsing of the mediate block 36 during cornering. Further, since the protrusions 95 are provided adjacent to the locations on both sides of the shoulder block 41 in the circumferential direction of the tire, it is possible to effectively prevent collapsing of the shoulder block 41 during cornering.

Further, since the shoulder main groove 15 is provided with more protrusions 95 than the center main groove 10, it is possible to prevent collapsing of the shoulder block 41 to which a larger force is applied during cornering, and moreover, the drainage performance for water or snow of the center main groove 10 is secured.

Further, because the notch 57 is formed at the location adjacent to the protrusion 90 in the mediate block 36, the water or the snow inhibited from flowing by the protrusion 90 can bypass to the notch 57 side. Therefore, the drainage performance for water or snow of the center main groove 10 is secured. Further, because the notch 67 is formed at the location adjacent to the protrusion 95 in the shoulder block 41, the water or the snow inhibited from flowing by the protrusion 95 can bypass to the notch 67 side. Therefore, the drainage performance for water or snow of the shoulder main groove 15 is secured.

Further, since the side 57b on the kick-out side of the triangular notch 57 on the center main groove 10 side in the mediate block 36 extends toward the tire width direction, and the side 67b on the kick-out side of the triangular notch 67 on the shoulder main groove 15 in the shoulder block 41 extends toward the tire width direction, the pneumatic tire 1 is excellent in traction performance.

The above embodiments are examples, and the scope of the present disclosure is not limited thereto. Various modifications maybe made to the above embodiments within the scope without escaping from the purpose of the present disclosure.

### DESCRIPTION OF REFERENCE NUMERALS AND SIGNS

C . . . tire equator, E . . . tire grounding end, 1 . . . pneumatic tire, 2 . . . bead portion, 2a . . . bead core, 2b . . . bead filler, 3 . . . tread rubber, 4 . . . side wall rubber, 5 . . . carcass ply, 6 . . . inner liner, 7 . . . belt, 10 . . . center main groove, 11 . . . first groove portion, 12 . . . second groove portion, 15 . . . shoulder main groove, 16 . . . first groove portion, 17 . . . second groove portion, 20 . . . first lateral groove, 25 . . . second lateral groove, 30 . . . center land portion, 35 . . . mediate land portion, 36 . . . mediate block, 40 . . . shoulder land portion, 41 . . . shoulder block, 52 . . . notch, 52a . . . side on stepped side, 52b . . . side on kick-out side, 53 . . . bottom surface, 54 . . . shelf portion, 57 . . . notch, 57a . . . side on stepped side, 57b . . . side on kick-out side, 58 . . . bottom surface, 62 . . . notch, 62a . . . side on stepped side, 62b . . . side on kick-out side, 63 . . . bottom surface, 67 . . . notch, 67a . . . side on stepped side, 67b . . . side on kick-out side, 68 . . . bottom surface, 69 . . . shelf portion, 90 . . . protrusion, 91 . . . upper surface, 92 . . . surface on stepped side, 93 . . . surface on kick-out side, 95 . . . protrusion, 96 . . . upper surface, 97 . . . surface on stepped side, 98 . . . surface on kick-out side

1. A pneumatic tire in which protrusions are provided in main grooves extending in a circumferential direction of the tire,
wherein upper surfaces of the protrusions are inclined so as to be higher on a tire grounding end side and lower on a tire equator side,
surfaces on stepped sides of the protrusions extend in a tire width direction, and
surfaces on kick-out sides of the protrusions are inclined such that a portion closer to the tire equator side approaches to the surfaces on the stepped sides.

2. The pneumatic tire according to claim 1, wherein land portions on the tire grounding end side of the main grooves are blocks partitioned by lateral grooves, and
the protrusions are provided to be adjacent to locations on both sides of the block in the circumferential direction of the tire.

3. The pneumatic tire according to claim 1, wherein notches are formed at locations adjacent to the protrusions of the land portions on the tire grounding end side of the main grooves.

4. The pneumatic tire according to claim 3, wherein the notches are triangles formed with a boundary between the main grooves and the land portions on the tire grounding end side of the main grooves as one side in a plan view, and sides on kick-out sides of the notches extend in the tire width direction more than sides on the stepped sides in a plan view.
